(19) United States
(12) Patent Application Publication
(10) Pub. No.: US 2024/0125954 A1
(43) Pub. Date: Apr. 18, 2024

(54) UTILITY POLE LOCALIZATION FROM AMBIENT DATA

(71) Applicant: NEC Laboratories America, Inc., Princeton, NJ (US)

(72) Inventors: Zhuocheng JIANG, Plainsboro, NJ (US); Yue TIAN, Princeton, NJ (US); Yangmin DING, East Brunswick, NJ (US); Sarper OZHARAR, Pennington, NJ (US); Ting WANG, West Windsor, NJ (US)

(73) Assignee: NEC Laboratories America, Inc., Princeton, NJ (US)

(21) Appl. No.: 18/485,240

(22) Filed: Oct. 11, 2023

Related U.S. Application Data
(60) Provisional application No. 63/415,354, filed on Oct. 12, 2022.

(51) Int. Cl. G01V 1/00; G01V 1/22; G01V 1/32

(52) U.S. Cl. CPC G01V 1/001; G01V 1/226; G01V 1/325; G01V 2210/43

(57) ABSTRACT

Systems and methods for utility pole localization employing a DFOS/DAS interrogator located at one end of an optical sensor fiber remotely capture dynamic strains on the optical sensor fiber induced by acoustic events. A captured two-dimensional spatiotemporal map in an ambient noisy environment is analyzed by a trained machine learning model which then automatically detects an area in which a pole is located without requiring domain knowledge. Original DFOS/DAS signals are separated into pole regions and non-pole region time series for machine learning model training. A contrastive loss function measures similarities between low-frequency and high-frequency features. A Gaussian distribution is applied to the original signals to generate weighted labels to eliminate effects of label noise. The machine learning model fuses low-frequency and high-frequency features in the frequency domain for pole region classification. A contrastive loss is combined with cross entropy loss to measure a low-high frequency feature distance.

### CROSS-REFERENCE TO RELATED APPLICATIONS

This application claims the benefit of U.S. Provisional Patent Application Ser. No. 63/415,354 filed Oct. 12, 2022, the entire contents of which is incorporated by reference as if set forth at length herein.

### FIELD OF THE INVENTION

This application relates to distributed fiber optic sensing (DFOS) systems, methods, and structures. More particularly, it pertains to utility pole localization from ambient data using distributed fiber optic sensing (DFOS)/distributed acoustic sensing (DAS).

### BACKGROUND OF THE INVENTION

Event detection of aerial fiber-optic cables and utility pole localization has been shown to be some of the more useful applications DFOS/DAS. Among millions of miles of telecommunications fiber optic cables deployed in the United States, a major portion are aerial fiber cables suspended from utility poles. Utility pole from DAS data enables the mapping of any point along the fiber onto its real-world geographic location.

Currently, localizing utility poles from DAS traces relies on human experts who manually label a pole location by examining DAS signal patterns generated in response to hammer knocks on the pole. However, this process is inefficient and expensive since it requires much manual effort to identify/label a pole location by manually knocking/impacting every pole, thus it is impractical for industrial applications.

### SUMMARY OF THE INVENTION

The above problems are solved and an advance in the art in is made according to aspects of the present disclosure directed to utility pole localization from ambient data using distributed fiber optic sensing (DFOS)/distributed acoustic sensing (DAS).

In sharp contrast to the prior art, our inventive systems and methods provide an efficient and low workforce solution for utility pole localization. A DFOS/DAS interrogator located at one end of an optical sensor fiber remotely captures dynamic strains on the optical sensor fiber induced by acoustic events. A captured two-dimensional spatiotemporal map in an ambient noisy environment is analyzed by a trained machine learning model which then automatically detects an area in which a pole is located without requiring domain knowledge. More specifically, original DFOS/DAS signals are separated into pole regions and non-pole regions time series for machine learning model training. A contrastive loss function is developed to measure similarities between low-frequency and high-frequency features. A Gaussian distribution is applied to the original signals to generate weighted labels to eliminate effects of label noise.

In further contrast to the prior art, our inventive machine learning model fuses low-frequency and high-frequency features in the frequency domain for pole region classification. A contrastive loss is combined with cross entropy loss to measure a low-high frequency feature distance, and the Gaussian distributed label re-weighting is utilized to eliminate the label noise.

### BRIEF DESCRIPTION OF THE DRAWING

FIG. 1(A) and FIG. 1(B) are schematic diagrams showing an illustrative prior art uncoded and coded DFOS systems;

FIG. 2. Is a schematic flow diagram showing an illustrative method of utility pole localization using ambient data according to aspects of the present disclosure;

FIG. 3 is a schematic diagram showing illustrative implementation details of utility pole localization using ambient data according to aspects of the present disclosure; and

FIG. 4 is a schematic block diagram showing illustrative features of utility pole localization using ambient data according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

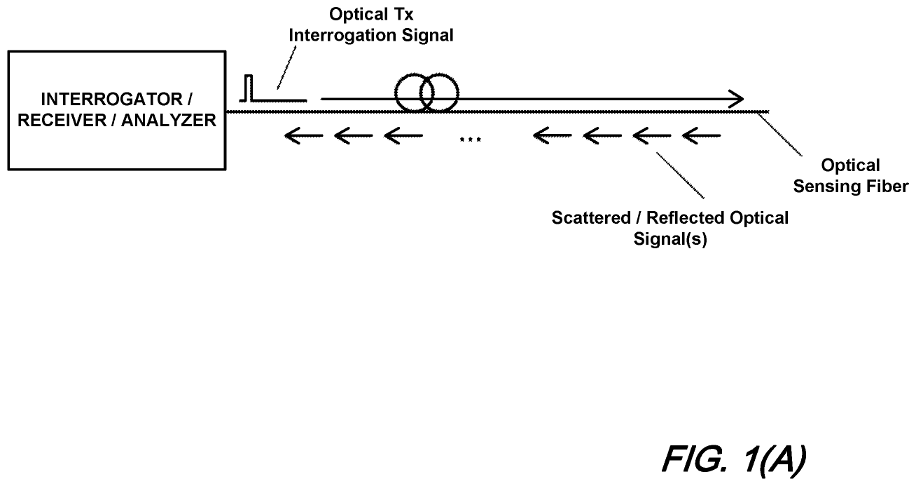

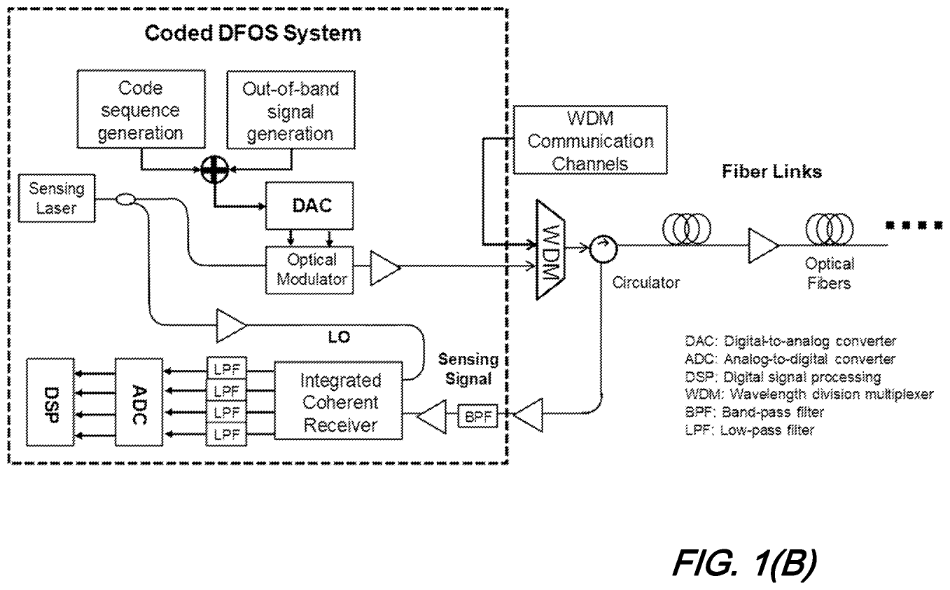

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. According to aspects of the present disclosure, classification methods may be further used to detect and locate events or other environmental conditions including acoustic and/or vibrational and/or thermal along the length of the optical sensing fiber.

As noted, the present disclosure describes DFOS/DAS systems, methods, and structures for utility pole localization using ambient data.

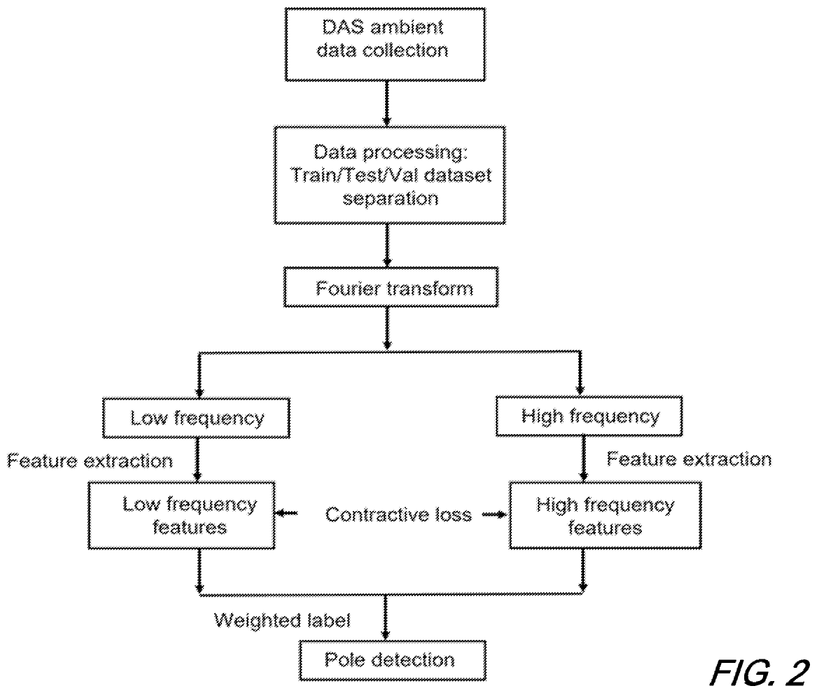

FIG. 2. Is a schematic flow diagram showing an illustrative method of utility pole localization using ambient data according to aspects of the present disclosure. Based on domain knowledge that acoustic vibration patterns captured directly from DFOS/DAS optical sensor fiber are different from acoustic vibration patterns that are transferred through a utility pole, a novel machine learning framework was developed to distinguish those two vibration patterns.

For data collection, a DFOS/DAS monitors acoustic vibrations with meter-scale spatial resolution in real-time. A preprocessing step separates original time series data into training, validation, and testing sets according to labeled pole geographical locations. Note that time series data are transformed into the frequency domain, then the frequency domain sequences are further separated into low frequency and high frequency for feature extraction. Extracted features are then concatenated for pole detection

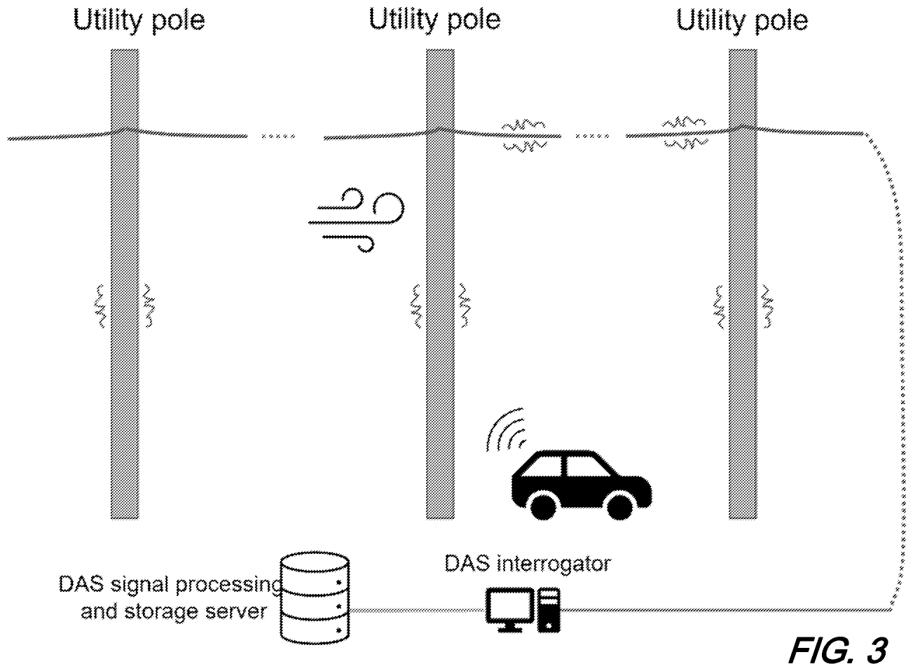

FIG. 3 is a schematic diagram showing illustrative implementation details of utility pole localization using ambient data according to aspects of the present disclosure.

With reference to FIG. 3, implementation details of our inventive method may be further understood as follows.

Data collection and labeling. A DFOS/DAS system located at one end of an optical sensor fiber is configured to capture real-time acoustic vibrations along tens of kilometers of fiber optic cable—including the optical sensor fiber—with meter-scale spatial resolution. Recorded raw data are linked to geographic locations of utility poles such that the locations along the optical sensor of the utility pole(s) are determined.

Data preprocessing. Original DFOS/DAS time series data are preprocessed and separated into a non-pole dataset and a pole-containing dataset. Then two datasets are equally partitioned into training, validation, and testing sets. Note that all the time series are transformed to the frequency domain.

Feature extraction. The preprocessed frequency series are separated into low-frequency parts and high-frequency parts for feature extraction, respectively. A multi-channel feature extractor generates a comprehensive representation by learning with different kernel sizes. Then, the learned features are fused and sent to a ResNet for pole region detection.

Contrastive loss and re-weighted label. A contrastive loss function is combined with cross entropy loss to measure similarities between the low-frequency and high-frequency features. A Gaussian distribution is applied to the original series to reweigh the data label due to the label noise.

With the pre-trained model ready, segmented spectral data from any optical sensor fiber locations being tested can be applied to the model. The pre-trained model then classifies segmented spectral data into the pole and straight-line classes. As a result, we can get the geographic locations of the pole. If the pre-trained model is ready and does not need an update, feature extraction and contrastive loss steps can be skipped.

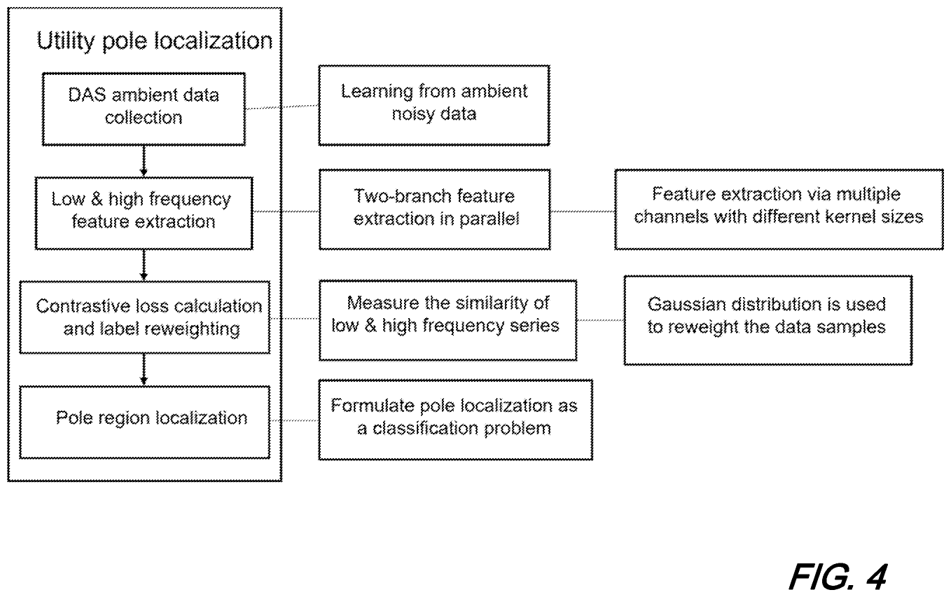

FIG. 4 is a schematic block diagram showing illustrative features of utility pole localization using ambient data according to aspects of the present disclosure.

At this point, while we have presented this disclosure using some specific examples, those skilled in the art will recognize that our teachings are not so limited. Accordingly, this disclosure should only be limited by the scope of the claims attached hereto.

1. A method of determining utility pole locations, the method comprising:
operating a distributed fiber optic sensing (DFOS) system configured to monitor ambient vibrational events affecting utility poles;
analyzing two-dimensional spatiotemporal time-series data received from the monitoring and separating the data into a training, validation, and testing sets according to labeled utility pole geographical locations;
transforming the time-series data into frequency domain data using a Fourier transform;
separating the transformed frequency domain data into low frequency data sequences and high frequency data sequences for feature extraction;
measure similarities between features extracted from the high frequency data sequences and low frequency data sequences and fusing learned features into a ResNet for pole detection;
applying further monitored two-dimensional spatiotemporal time-series data to the ResNet for determination of utility pole location; and
outputting an indicium of utility pole locations.

2. The method of claim 1 further comprising applying a Gaussian distribution to the measured similarities.
